(19) United States
(12) Patent Application Publication
(10) Pub. No.: US 2025/0053990 A1
(43) Pub. Date: Feb. 13, 2025

(54) CUSTOMER RECORDS MANAGEMENT TRANSLATION EXTENSION

(71) Applicant: Capital One Services, LLC, McLean, VA (US)

(72) Inventors: Alexander BAILEY, Little Elm, TX (US); Bharathi MANI, Frisco, TX (US)

(73) Assignee: Capital One Services, LLC, McLean, VA (US)

(21) Appl. No.: 18/231,491

(22) Filed: Aug. 8, 2023

(51) Int. Cl. G06Q 30/015; G06F 9/54

(52) U.S. Cl. CPC G06Q 30/015; G06F 9/547

(57) ABSTRACT

Disclosed herein are system, method, and computer program product embodiments for a customer records management translation extension. A computer system receives customer data comprising a first name, last name, an email address, and a phone number from a front-end interface of an agent workstation. Based on the customer data, the computer system obtains one or more customer objects from a customer object database, wherein each of the customer object comprises a customer identifier. The computer system selects the customer object that best matches the customer data and obtains a customer lead identifier from the customer object database that corresponds to the customer identifier of the selected customer object. Based on the customer lead identifier, the computer system obtains a lead object from a lead object database and generates a link to the lead object. Finally, the computer system transmits the link to the front-end interface of the agent workstation.

### BACKGROUND

Car dealers, realtors, and other sales agents may have several windows or tabs open in a web browser application that refer to the same lead (e.g., an existing or potential customer) for a possible sales transaction from a customer records management system operated by the agent and a lead provider site. When pursuing multiple sales transactions, an agent may have many tabs open in the web browser application. Having too many windows or tabs open in a web browser application may consume a disproportionate amount of a processing resources, which may result in an overall degradation in a computer's performance and/or the agent's experience with a web browser application. Although an agent can improve the performance of the computer or web browser application by limiting the number of tabs, manually opening a new tab in the web browser application to search for a customer by name in a lead provider site after having seen the customer data on the agent's customer records management system in another tab can be time-consuming and susceptible to error. Accordingly, what is needed is an improved method and system that saves time and provides an agent flexibility by automatically translating a lead from the agent's customer records management system to the same lead on a lead provider site without requiring additional windows or tabs to be opened in a web browser application.

### BRIEF DESCRIPTION OF THE DRAWINGS

The accompanying drawings, which are incorporated herein and form a part of the specification, illustrate the embodiments and, together with the description, further serve to explain the principles of the embodiments and to enable a person skilled in the relevant art(s) to make and use the embodiments.

FIG. 1 illustrates a block diagram of an example system for providing a customer records management translation extension, in accordance with aspects of the disclosure.

FIG. 2 illustrates a flow diagram of an example method for providing a link to a lead object corresponding to an identified customer, in accordance with aspects of the disclosure.

FIG. 3 illustrates a flow diagram of an example method for identifying a lead object using customer data obtained from a customer records management (CRM) system interface, in accordance with aspects of the disclosure.

FIGS. 4A and 4B illustrate an example message flow between components of an example system for providing a customer records management translation extension, in accordance with aspects of the disclosure.

FIGS. 5A-5D illustrate example graphical user interfaces produced by the example system for providing a customer records management translation extension, in accordance with aspects of the disclosure.

FIG. 6 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a customer records management translation extension.

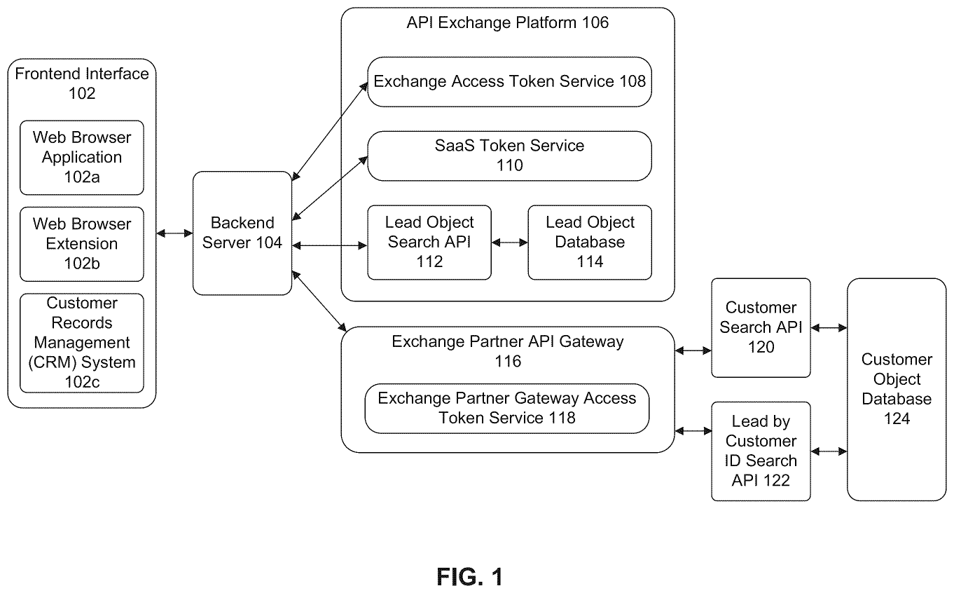

FIG. 1 illustrates a block diagram of an example system 100 for providing a customer records management translation extension, in accordance with aspects of the disclosure. As shown in FIG. 1, the system 100 may include a frontend interface 102, a backend server 104, an application programming interface (API) exchange platform 106, an exchange access token service 108, a software-as-a-service (SaaS) token service 110, a lead object search API 112, a lead object database 114, an exchange partner API gateway 116, an exchange partner gateway access token service 118, a customer search API 120, a lead by customer identifier (ID) search API 122, and a customer object database 124.

In some embodiments, the frontend interface 102 may be a graphical user interface of a software application executing on an agent workstation. An agent may be a salesperson at a vehicle dealership, a realtor at a real estate agency, or the like. An agent workstation may be a desktop computer, laptop computer, tablet computer, smartphone, cellular telephone, personal digital assistant, or any other type of computing device. Software applications may include a web browser application 102a and a web browser extension 102b. Web browser applications 102a enable users to access websites and resources that are located on remote servers. Some examples of web browser applications 102a may include Google Chrome™, Mozilla Firefox™, Microsoft Edge™, Opera™, and Apple Safari™.

In some embodiments, an agent may use a web browser application 102a to access a customer records management (CRM) system 102c. In one embodiment, a CRM system 102c may be a tool that enables businesses to track customer data and manage relationships with customers. A CRM system 102c may aggregate personal details regarding existing and potential customers, such as their first names, last names, addresses, and job titles. The CRM system 102c may also collect historical data regarding interactions between a business entity and the customer, such as engagement with marketing campaigns, phone calls to customer support, prior purchases, and demonstrated interest in particular products or services. Furthermore, the CRM system 102c may analyze customer data in order to help businesses identify new sales opportunities and provide improved services to their customers.

In some embodiments, the web browser extension 102b may be a software module that integrates an additional service or functionality into the web browser application 102a. In at least one embodiment, the additional service or functionality provided by web browser extension 102b may include obtaining a link to proprietary lead data using data obtained from the CRM system 102c on the agent's workstation. In one embodiment, an agent may activate the web browser extension 102b by clicking an icon for the web browser extension 102b in the toolbar of the web browser application 102a. The web browser extension 102b may obtain customer data from the CRM system 102c displayed in one or more open tabs of the web browser application 102a and pass the customer data to a backend server 104 for further processing.

In some embodiments, the backend server 104 may be a client workstation or server device (e.g., host server, cloud server, web server, application server, etc.). In one embodiment, a backend-for-frontend (BFF) application may be implemented on the backend server 104. In this embodiment, the BFF application may receive customer data obtained from the web browser extension 102b of the frontend interface 102 and execute a backend search process comprising a series of application programming interface (API) calls to identify proprietary lead data corresponding to the customer data obtained from CRM system 102c.

In some embodiments, an API exchange platform 106 may be a server device (e.g., a host server, cloud server, web server, application server, etc.) that hosts and regulates access to one or more application programming interfaces (APIs). As shown in FIG. 1, the API exchange platform 106 may comprise the exchange access token service 108, the Software-as-a-Service (SaaS) token service 110, the lead object search API 112, and the lead object database 114.

In some embodiments, an API may be a software program that enables data transfer between one software application and another software application or external database. For example, when a software application requires data from an external database, the software application may initiate an API call to a particular API requesting the data. The API call may comprise a uniform resource identifier (URI) identifying the API, a request verb, headers, a request body, and one or more access tokens. After receiving and authenticating the API call, the API may request the data specified in the API call from the external database. The external database may respond by transmitting the requested data to the API, and the API may transfer the requested data to the software application.

In some embodiments, the exchange access token service 108 may generate an exchange access token in response to a request from a software application, such as the BFF application on backend server 104. In one embodiment, an exchange access token may be a segment of software code that can be used by the BFF application to access one or more APIs hosted on the API exchange platform 106. The exchange access token may include an access token string, token expiration, and potentially one or more scopes assigned to the access token. An access token string may be a series of random characters that can be used to verify an incoming API request. The token expiration may define how long the access token is valid and can be used to access the API. The one or more scopes may be parameters that define particular resources that the BFF application has been granted permission to access.

In some embodiments, the BFF application may request an exchange access token from exchange access token service 108. The request may include an application identifier (ID) and an application secret to the exchange access token service 108. The application ID may be a unique, public identifier for the BFF application, and the application secret may be a password that is known only to the BFF application and the exchange access token service 108. The exchange access token service 108 may authenticate the request for an exchange access token using the application ID and the application secret. If the request is valid, the exchange access token service 108 may generate the exchange access token and pass the access token to the BFF application. Afterwards, the BFF application may use the exchange access token in an API call as a credential that informs the API that the BFF application has been authorized to access the API and perform specific operations as defined by the assigned scope(s).

In some embodiments, the SaaS token service 110 may generate a SaaS token in response to a request from the BFF application on backend server 104. The request may include an agent's user ID and dealer ID. The user ID and dealer ID may be provided by the agent via an input interface. Alternatively, the user ID and dealer ID may be obtained from an ID token stored on the agent workstation. The SaaS token service 110 may authenticate the request using the user and dealer IDs. If the request is valid, the SaaS token service 110 may generate and return a SaaS token to the BFF application. In one embodiment, one or more APIs may use the SaaS token to ensure that certain resources are accessible only to an authorized user and organization.

In some embodiments, lead object search API 112 may be an API that is configured to retrieve one or more lead objects from a lead object database 114. The lead object search API 112 and lead object database 114 may be developed and maintained by a financial institution or lead provider such as Dealer Navigator™. Each lead object in the lead object database 114 may contain proprietary and sensitive customer information including, but not limited to, a customer lead identifier (ID), demographic data, income data, credit scores, one or more preferences for an item of interest (e.g., vehicles, real estate, etc.), and loan pre-approval status. In one embodiment, the BFF application on backend server 104 may call the lead object search API 112. The API call may include a lead source parameter identifying the lead object database 114, a customer lead ID, an exchange access token, and a SaaS token. The lead object search API 112 may authenticate the API call using the lead source parameter, exchange access token, and SaaS token. If the API call is valid, the lead object search API 112 may retrieve a lead object with the customer lead ID specified in the API call from the lead object database 114.

In some embodiments, the exchange partner API gateway 116 may be a proxy server device (e.g., a host server, cloud server, web server, application server, etc.) configured to direct API calls to the correct endpoint(s) of one or more third-party APIs. The exchange partner API gateway 116 may route the API call to the appropriate API based on one or more parameters contained in the API call including, but not limited to, a URI identifying the API, an application ID, or a subscription identifier (ID) that is unique to a combination of an application and client. As shown in FIG. 1, the exchange partner API gateway 116 may include an exchange partner gateway access token service 118 to regulate access to the one or more third-party APIs. Furthermore, in at least one embodiment, the one or more third-party APIs may include a customer search API 120 and a lead by customer ID search API 122.

In some embodiments, the exchange partner gateway access token service 118 may generate an exchange partner gateway access token in response to a request from the BFF application on backend server 104. Similar to the exchange access token, the exchange partner gateway access token may be a segment of software code that can be used by the BFF application to access one or more APIs on the exchange partner API gateway 116. An exchange partner gateway access token may also include an access token string, token expiration, and potentially one or more scopes assigned to the token. The BFF application may request an exchange partner gateway access token from the exchange partner gateway access token service 118 by submitting the exchange access token obtained from the exchange access token service 108 and a subscription ID. In at least one embodiment, the subscription ID may be a unique identifier assigned to the BFF application. The exchange partner gateway access token service 118 may authenticate the request based on the exchange access token and the subscription ID. If the request is valid, the exchange partner gateway access token service 118 may generate an exchange partner gateway access token and pass the access token to the BFF application.

In some embodiments, the customer search API 120 may be an API that is configured to retrieve one or more customer objects from a customer object database 124. Customer objects in the customer object database 124 may each contain contact information for a specific customer aggregated from various third-party sources. This information may include, but is not limited to, a customer's first name, last name, phone number, email address, customer identifier (ID), and customer lead identifier (ID). In one embodiment, the BFF application on backend server 104 may call the customer search API 120. The API call may include the customer data obtained from CRM system 102c, an exchange access token, and an exchange partner gateway access token. The customer search API 120 may authenticate the API call using the exchange access token and the exchange partner gateway access token. If the API call is valid, the customer search API 120 may retrieve one or more customer objects that match the customer data specified in the API call from the customer object database 124. The customer search API 120 may return the identified one or more customer objects to the BFF application.

In some embodiments, the lead by customer ID search API 122 may be an API that is configured to translate the customer ID of the customer object that best matches the customer data from CRM 102c to a customer lead ID. In one embodiment, the BFF application on backend server 104 may call the lead by customer ID search API 122. The API call may include the customer ID of the best matching customer object, an exchange access token, and an exchange partner gateway access token. The lead by customer ID search API 122 may authenticate the API call using the exchange access token and the exchange partner gateway access token. If the API call is valid, the lead by customer ID search API 122 may retrieve the customer lead ID corresponding to the customer ID specified in the API call from the customer object database 124. The lead by customer ID search API 122 may return the customer lead ID to the BFF application.

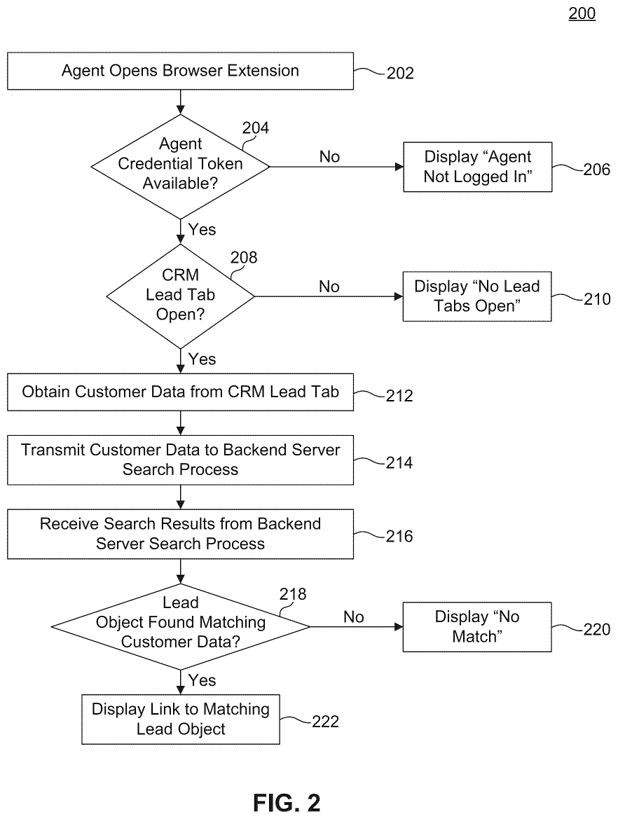

FIG. 2 illustrates a flow diagram of an example method 200 for providing a link to a lead object corresponding to an identified customer, in accordance with aspects of the disclosure.

In some aspects, method 200 may begin with operation 202, which may include opening the web browser extension 102b. In one embodiment, an agent may open or activate the web browser extension 102b by clicking on an icon for the web browser extension 102b in the toolbar of the web browser application 102a.

In some aspects, operation 204 may include determining if a valid agent credential token is available on the agent workstation. In one embodiment, an agent credential token may be an ID token issued by an Identity Provider upon receiving valid login credentials from a user. An Identity Provider may be a lead provider site such as Dealer Navigator™ An ID token may include an identifier for the issuer entity, an identifier for the application intended to receive the token, expiration time, user identifier, dealer identifier, as well as other information about the user. If a valid agent credential token is not available, the method may proceed to operation 206 and output an “Agent Not Logged In” message on the display interface of the agent workstation and terminate. If a valid agent credential token is available, the method may proceed to operation 208.

In some aspects, operation 208 may include determining if one or more customer records management (CRM) lead tabs are open in a web browser application 102a. In one embodiment, the presence of one or more open CRM lead tabs may be identified based on the uniform resource locator (URL) in the address bar of web browser application 102a. For example, if the address bar of an open window of web browser application 102a contains the URL of a CRM customer page, web browser extension 102b may determine that at least one CRM lead tab is open.

If no CRM lead tabs are open, the method may proceed to operation 210. In some aspects, operation 210 may include outputting a “No Lead Tabs Open” message or similar message on a display interface of the agent workstation. If at least one CRM lead tab is open, the method may proceed to operation 212.

In some aspects, operation 212 may include obtaining customer data from the one or more open CRM lead tabs in web browser application 102a. In one embodiment, web browser extension 102b may obtain customer data from the one or more open CRM lead tabs using a template that identifies the location of particular data elements (e.g., first name, last name, email address, phone number, etc.) in a CRM customer page. In another embodiment, web browser extension 102b may obtain customer data from the one or more open CRM lead tabs by performing an optical character recognition scan of each CRM customer page in the one or more CRM lead tabs. Afterwards, web browser extension 102b may identify relevant prompts in the CRM customer page and determine the location of particular data elements based on the identified prompts. Web browser extension 102b may further extract customer data from the identified locations in the CRM customer page.

In some aspects, operation 214 may include transmitting the extracted customer data to a backend server search process. Web browser extension 102b may transmit the customer data to a backend server 104. In one embodiment, a backend-for-frontend (BFF) application may receive customer data from the web browser extension 102b and execute a search process comprising a series of API calls to identify a lead object that matches the customer data obtained at operation 212.

In some aspects, operation 216 may include receiving search results from the BFF application on backend server 104. As mentioned earlier, search results may include a link to the identified lead object.

If the BFF application on backend server 104 does not return a link to a lead object matching the customer data obtained at operation 212, the method may proceed to operation 220. In some aspects, operation 220 may include outputting a “No Match” message on the display interface of the agent workstation. If the BFF application on backend server 104 returns a link to a lead object that matches the customer data obtained at operation 212, the method may proceed to operation 222.

In some aspects, operation 222 may include outputting a link to the identified lead object on the display interface of the agent workstation.

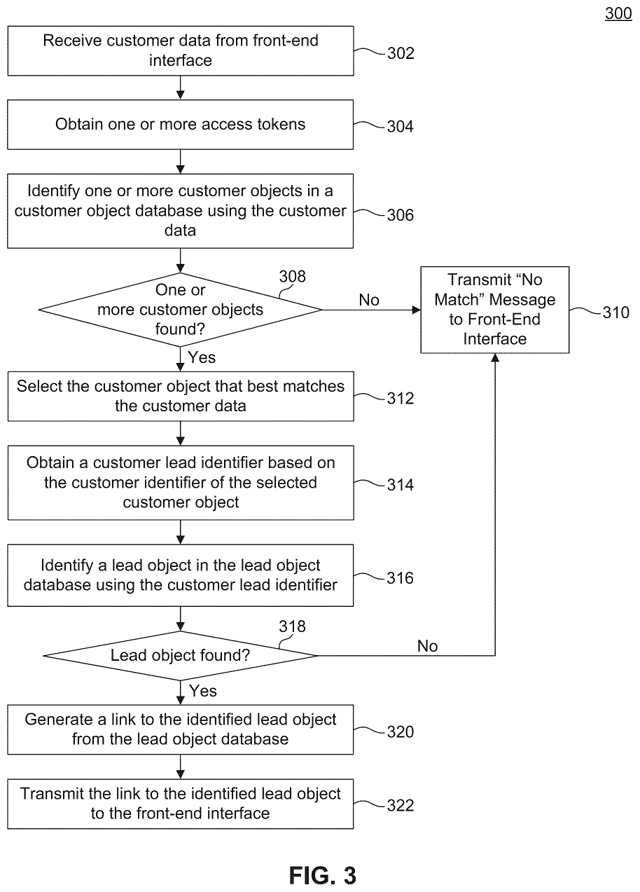

FIG. 3 illustrates a flow diagram of an example method 300 for identifying a lead object using customer data obtained from a customer records management (CRM) system interface, in accordance with aspects of the disclosure.

In some aspects, operation 302 may include receiving customer data from front-end interface 102. In one embodiment, web browser extension 102b may transmit customer data extracted from a CRM interface 102c in one or more tabs of web browser application 102a to a backend-for-frontend (BFF) application on backend server 104.

In some aspects, operation 304 may include obtaining one or more access tokens. In one embodiment, the one or more access tokens may include an exchange access token from exchange access token service 108 and/or an exchange partner gateway access token from exchange partner gateway access token service 118. The BFF application on backend server 104 may execute a search process comprising a series of API calls to identify a lead object corresponding to the customer data received at operation 302. The BFF application may include the one or more access tokens as authentication credentials in the API calls, wherein the access tokens inform the APIs that the BFF application is authorized to access the APIs and perform specific operations. Furthermore, one or more API calls may also require a Software-as-a-Service (SaaS) token from SaaS token service 110. The one or more APIs may use the SaaS token to ensure that certain resources are accessible only to an authorized user and organization.

In some aspects, operation 306 may include identifying one or more customer objects in a customer object database using the customer data received at operation 302. Customer objects in the customer object database may include data aggregated from various third-party sources such as the customer's first name, last name, phone number, email address, customer identifier (ID), and customer lead identifier (ID). In one embodiment, the BFF application may initiate a first API call to a customer search API 120. The API call may include the customer data received at operation 302 (e.g., first name, last name, email address, and phone number) and the one or more access tokens obtained at operation 304. The customer search API 120 may search the customer object database 124 to identify one or more customer objects that match the customer data specified in the API call. The customer search API 120 may return the identified one or more customer objects to the BFF application.

In some aspects, operation 308 may include determining if one or more customer objects were found at operation 306. If the customer search API 120 does not identify and return at least one matching customer object from customer object database 124 to the BFF application, method 300 may proceed to operation 310. In some aspects, operation 310 may include transmitting a “No Match” message to the web browser extension 102b of front-end interface 102. Operation 310 may also include outputting the “No Match” message on the display interface of the agent workstation. If the customer search API 120 returns one or more matching customer objects to the BFF application, method 300 may proceed to operation 312.

In some aspects, operation 312 may include selecting the customer object that best matches the customer data received at operation 302. In one embodiment, selecting the best matching customer object may entail choosing the customer object with data elements that match most, if not all, of the customer data received at operation 302. Operation 312 may further include extracting the customer identifier (ID) from the selected customer object.

In some aspects, operation 314 may include obtaining a customer lead identifier (ID) based on the customer ID of the selected customer object. In one embodiment, the BFF application may initiate a second API call to a lead by customer ID search API 122. The API call may include the customer ID of the selected customer object and the one or more access tokens. The lead by customer ID search API 122 may search the customer object database 124 to identify a customer lead ID corresponding to the customer ID specified in the API call. The lead by customer search API 122 may return the customer lead ID to the BFF application.

In some aspects, operation 316 may include identifying a lead object in a lead object database 114 using the customer lead ID obtained at operation 314. Lead objects in the lead object database 114 may contain proprietary and sensitive customer information including a customer lead ID, demographic data, income data, credit scores, one or more preferences for an item of interest (e.g., vehicles, real estate, etc.), and a loan pre-approval status. In one embodiment, the BFF application may initiate a third API call to a lead object search API 112. The API call may include a lead source parameter identifying lead object database 114, a customer lead ID, the one or more access tokens, and a SaaS token. The lead object search API 112 may search the lead object database 114 to identify a lead object with the customer lead ID specified in the API call.

In some aspects, operation 318 may include determining if a lead object was found. If the lead object search API 112 does not identify and return one lead object from lead object database 114 to the BFF application, method 300 may proceed to operation 310. In some aspects, operation 310 may include transmitting a “No Match” message to the web browser extension 102b of front-end interface 102. Operation 310 may additionally include outputting the “No Match” message on the display interface of the agent workstation. If the lead object search API 112 returns a lead object to the BFF application, method 300 may proceed to operation 320.

In some aspects, operation 320 may include generating a link to the identified lead object.

In some aspects, operation 322 may include transmitting the link to the identified lead object to the web browser extension 102b of front-end interface 102. Operation 322 may also include outputting the link on the display interface of the agent workstation.

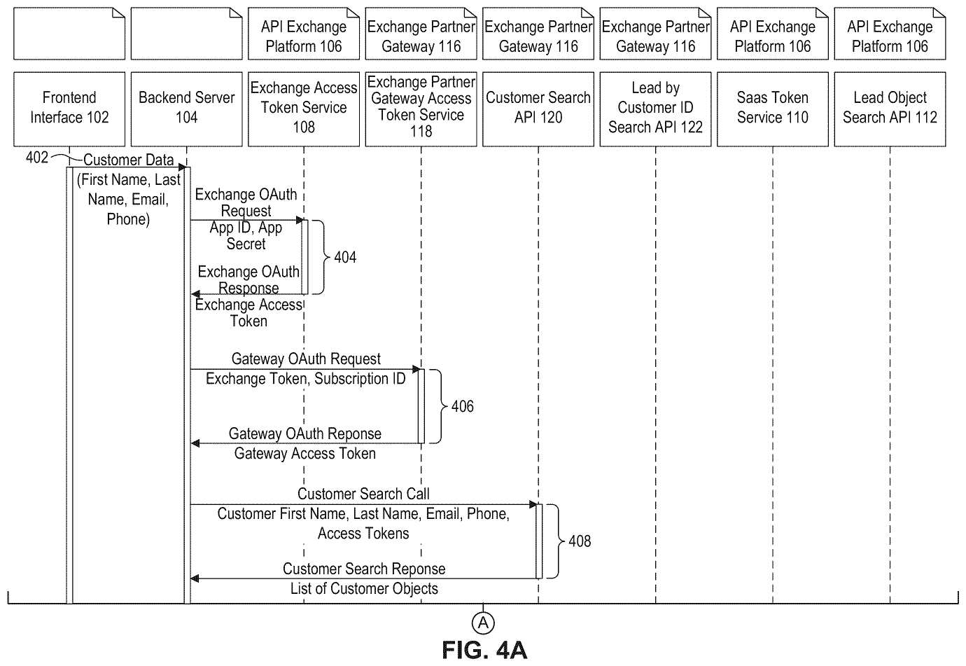

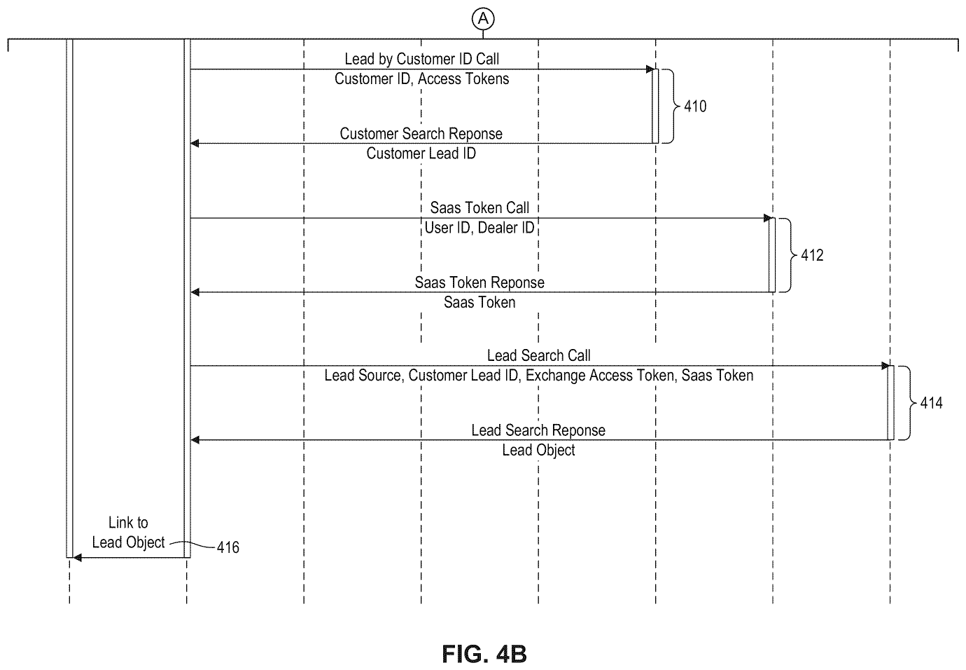

FIGS. 4A and 4B illustrate an example message flow diagram 400 depicting message flows between components of an example system 100 for providing a customer records management translation extension, in accordance with aspects of the disclosure.

In some aspects, message flow diagram 400 may begin with message flow 402, which may include receiving customer data from front-end interface 102. In one embodiment, web browser extension 102b may transmit customer data extracted from a CRM interface 102c in one or more tabs of web browser application 102a to a BFF application on backend server 104. The customer data may include a first name, a last name, an email address, and a phone number.

In some aspects, message flow 404 may include the BFF application submitting a request for an exchange access token to the exchange access token service 108. In one embodiment, the request may include an application identifier (ID) and an application secret to the exchange access token service 108. The application ID may be a unique, public identifier for the BFF application, and the application secret may be a password that is known only to the BFF application and the exchange access token service 108. If the request is valid, the exchange access token service 108 may generate and transmit an exchange access token to the BFF application.

In some aspects, message flow 406 may include the BFF application submitting a request for an exchange partner gateway access token to the exchange partner gateway access token service 118. In one embodiment, the request may include an exchange access token and a subscription identifier (ID). The subscription ID may be a unique identifier assigned to the BFF application. If the request is valid, the exchange partner gateway access token service 118 may generate and transmit an exchange partner gateway access token to the BFF application.

In some aspects, message flow 408 may include the BFF application initiating a first API call to a customer search API 120. The API call may include customer data received at message flow 402 (e.g. first name, last name, email address, phone number), an exchange access token, and an exchange partner gateway access token. In at least one embodiment, the exchange partner API gateway 116 may initially receive the first API call before directing the API call to an endpoint of the customer search API 120 based the on one or more parameters included in the API call. The customer search API 120 may search the customer object database 124 to identify one or more customer objects that match the customer data in the API call. The customer search API 120 may return the identified one or more customer objects to the BFF application.

If the customer search API 120 returns a customer object to the BFF application, the BFF application may extract the customer ID from the returned customer object. However, if the customer search API returns more than one customer object to the BFF application, the BFF application may select the customer object with data elements that best match the customer data received at message flow 402. The BFF application may extract the customer ID of the selected customer object.

In some aspects, message flow 410 may include the BFF application initiating a second API call to a lead by customer ID search API 122. The API call may include the extracted customer ID, an exchange access token, and an exchange partner gateway access token. Similar to the first API call, the second API call to the lead by customer ID search API 122 may initially be sent to the exchange partner API gateway 116. Afterwards, the exchange partner API gateway 116 may route the API call to an endpoint of the lead by customer ID search API 122 based on the one or more parameters included in the API call.

The lead by customer ID search API 122 may search the customer object database 124 for a customer lead ID corresponding to the customer ID specified in the API call. The lead by customer ID search API 122 may return the customer lead ID to the BFF application.

In some aspects, message flow 412 may include the BFF application transmitting a request for a Software-as-a-Service (SaaS) token from SaaS token service 110. The request may include the agent's user ID and dealer ID. If the request is valid, the SaaS toke service 110 may generate and transmit a SaaS token to the BFF application.

In some aspects, message flow 414 may include the BFF application initiating a third API call to a lead object search API 112. The API call may include a lead source parameter identifying lead object database 114, a customer lead ID, the exchange access token, and the SaaS token. The lead search API 112 may search the lead object database 114 to identify a lead object with the customer lead ID specified in the API call. If the lead search API 112 identifies a lead object, the lead search API 112 may return the lead object to the BFF application.

In some aspects, message flow 416 may include the BFF application generating and transmitting a link to the lead object to the web browser extension 102b of front-end interface 102.

Although FIGS. 2, 3, and 4A and 4B depict steps that are performed in a particular order for purposes of illustration and discussion, the methods of the present disclosure are not limited to the particularly illustrated order or arrangement. The various steps of methods 200 and 300 and message flow diagram 400 can be omitted, rearranged, combined, or adapted without deviating from the scope of the present disclosure. Furthermore, methods 200 and 300 and message flow diagram 400 can be performed by processing logic that can comprise hardware (e.g., circuitry, dedicated logic, programmable logic, microcode, etc.), software (e.g., instructions executing on a processing device), or a combination thereof.

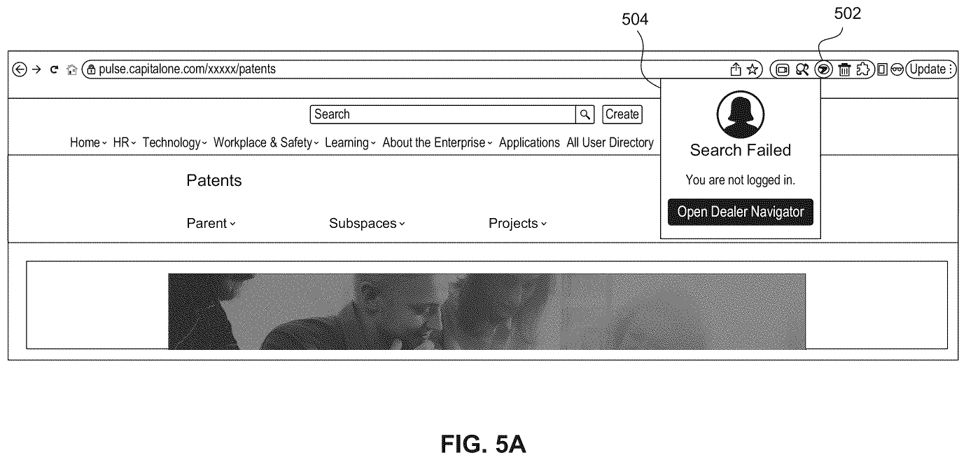

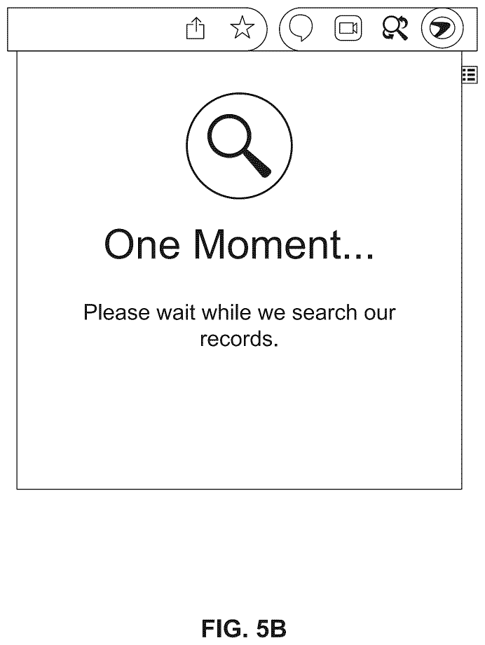

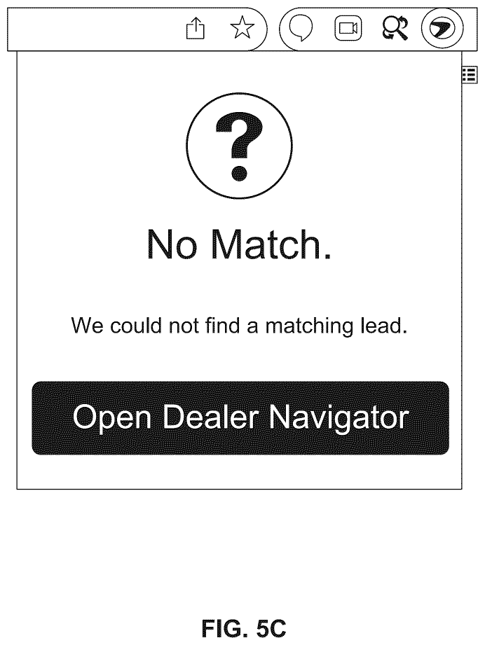

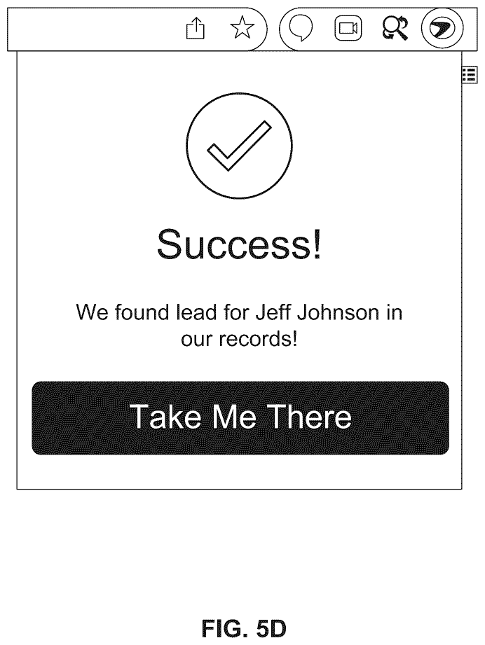

FIGS. 5A-5D illustrate graphical user interfaces generated by the example system 100 for providing a customer records management translation extension, in accordance with aspects of the disclosure.

FIG. 5A depicts an example interface of a web browser application 102a. Element 502 shows an example icon for web browser extension 102b. Upon clicking on the icon, the web browser extension 102b may search for an identity token on the agent workstation. If an identity token is available, the web browser extension 102b may obtain customer data from CRM interface 102c in one or more open tabs of the web browser application 102a and send the customer data to a BFF application on backend server 104. If the web browser extension 102b cannot locate an identity token, the web browser extension 102b may present a link to the lead provider service (e.g., Dealer Navigator™) in a pop-up window, as illustrated in element 504. In this scenario, an agent may click on this link to access the lead provider service in another window or tab of web browser application 102a. Afterward, the agent may enter his login credentials to receive an identity token from the lead provider service.

FIG. 5B depicts an example interface that web browser extension 102b may display to the agent as the BFF application searches for a lead object that matches the customer data previously obtained from CRM interface 102c in one or more open tabs of the web browser application 102a.

FIG. 5C depicts an example interface that web browser extension 102b may display to the agent when the BFF application cannot return a matching lead object for customer data obtained from CRM interface 102c in one or more open tabs of web browser application 102a. The web browser extension 102b may present the example interface if the customer search API 120 is unable to identify a customer object in the customer object database 124 or if the Lead Search API 112 is unable to locate a lead object in the lead object database 114. As illustrated by the figure, the example interface may include a link the agent may use to access the lead provider service for further searching in another window or tab of the web browser application 102a.

FIG. 5D depicts an example interface that web browser extension 102b may display to the agent when the BFF application returns a lead object that matches the customer data obtained from CRM interface 102c in one or more open tabs of web browser application 102a. The figure illustrates that the example interface may include a link to the lead object. When the agent clicks on the link, the web browser extension 102b may display the lead data in the current pop-up window or another tab of web browser application 102a. Furthermore, the web browser extension 102b may additionally include functionality that enables an agent to import lead data displayed in the pop-window or tab of the web browser application 102a to relevant data fields in one or more documents (e.g., a sales offer, a sales contract, an auto loan application, mortgage loan application, credit card application, etc.).

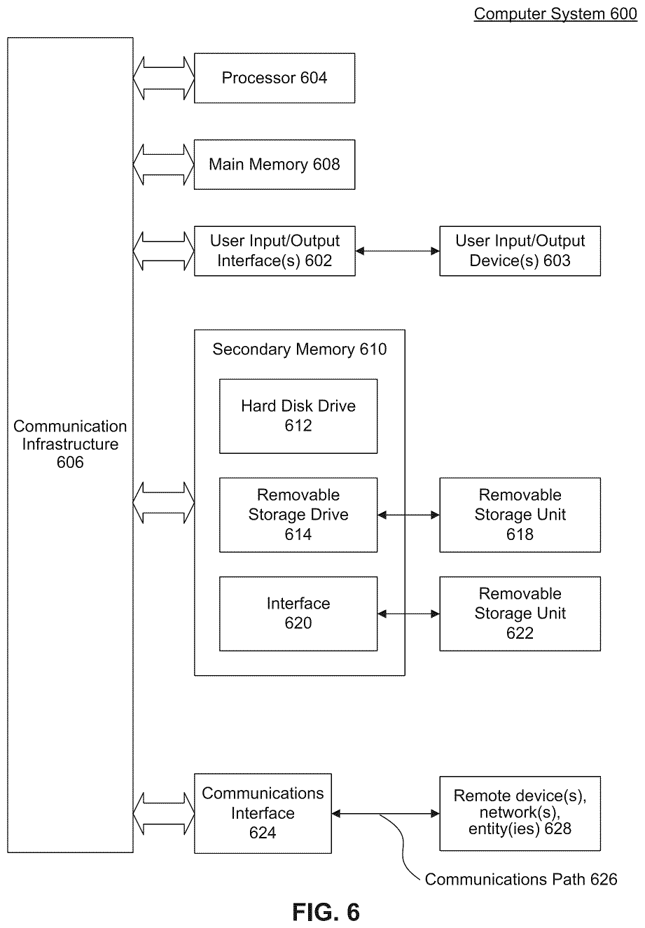

FIG. 6 illustrates an example computer system 600 (e.g., the backend subsystem 104 of system 100) useful for implementing various embodiments. Computer system 600 may include one or more well-known computer systems capable of performing the operations and functions described herein. One or more computer systems 600 may be used, for example, to implement any of the various embodiments discussed herein, as well as combinations and sub-combinations thereof.

Computer system 600 may include one or more processors, such as a processor 604. Processor 604 may execute software to perform the operations described herein. In some embodiments, processor 604 may be a central processing unit (CPU), a graphics processing unit (GPU), a digital signal processors (DSP), one or more application specific integrated circuits (ASICs), or any combination of these. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships (or equivalents thereof) are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such applications and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of this disclosure should not be limited by any of the above-described exemplary embodiments, but should be defined only in accordance with the following claims and their equivalents.

What is claimed is:

1. A method, comprising:
receiving, by a cloud server, customer data from a front-end interface of an agent workstation, wherein the customer data comprises a first name, a last name, an email address, and a phone number;
obtaining, by the cloud server and based on the customer data, one or more customer objects from a customer object database, wherein each of the one or more customer objects comprises a customer identifier;
selecting, by the cloud server, the customer object that best matches the customer data;
obtaining, by the cloud server and based on the customer identifier of the selected customer object, a customer lead identifier from the customer object database;
obtaining, by the cloud server and based on the customer lead identifier, a lead object from a lead object database;
generating, by the cloud server, a link to the lead object from the lead object database; and
transmitting, by the cloud server, the link to the lead object to the front-end interface of the agent workstation.

2. The method of claim 1, wherein the lead object comprises one or more vehicle preferences, income data, and loan pre-approval status.

3. The method of claim 1, the method further comprising:
submitting, by the cloud server, a first request to an exchange access token service of an application programming interface (API) exchange platform for an exchange access token, wherein the first request comprises an application identifier and an application secret;
obtaining, by the cloud server and based on the first request, the exchange access token;
submitting, by the cloud server, a second request to a gateway access token service of an exchange partner gateway for a gateway access token, wherein the second request comprises the exchange access token and a subscription identifier; and
obtaining, by the cloud server and based on the second request, the gateway access token.

4. The method of claim 3, wherein the obtaining one or more customer objects from a customer object database further comprises:
invoking, by the cloud server, a first call to a customer search API, wherein the first call to the customer search API comprises the customer data, the exchange access token, and the gateway access token.

5. The method of claim 4, wherein the obtaining the customer lead identifier from the customer object database further comprises:
invoking, by the cloud server, a second call to a lead by customer identifier search API, wherein the second call to the lead by customer identifier search API comprises the customer identifier, the exchange access token, and the gateway access token.

6. The method of claim 5, the method further comprises:
submitting, by the cloud server, a third request to a software-as-a-service (Saas) token service of the API exchange platform for a Saas token, wherein the third request comprises a user identifier and a dealer identifier; and
receiving, by the cloud server and based on the third request, the Saas token.

7. The method of claim 6, wherein the obtaining the lead object from the lead object database further comprises:
invoking, by the cloud server, a third call to a lead object search API, wherein the third call to the lead object search API comprises a lead source identifier, the customer lead identifier, the exchange access token, and the Saas token.

8. A non-transitory computer readable medium storing instructions that, when executed by one or more processors, causes the one or more processors to perform operations comprising:
receiving customer data from a front-end interface of an agent workstation, wherein the customer data comprises a first name, a last name, an email address, and a phone number;
obtaining, based on the customer data, one or more customer objects from a customer object database, wherein each of the one or more customer objects comprises a customer identifier;
selecting the customer object that best matches the customer data;
obtaining, based on the customer identifier of the selected customer object, a customer lead identifier from the customer object database;
obtaining, based on the customer lead identifier, a lead object from a lead object database;
generating a link to the lead object from the lead object database; and
transmitting the link to the lead object to the front-end interface of the agent workstation.

9. The non-transitory computer-readable medium of claim 8, wherein the lead object comprises one or more vehicle preferences, income data, and loan pre-approval status.

10. The non-transitory computer-readable medium of claim 8, wherein the operations further comprise:
submitting a first request to an exchange access token service of an application programming interface (API) exchange platform for an exchange access token, wherein the first request comprises an application identifier and an application secret;
obtaining, based on the first request, the exchange access token;
submitting a second request to a gateway access token service of an exchange partner gateway for a gateway access token, wherein the second request comprises the exchange access token and a subscription identifier; and
obtaining, based on the second request, the gateway access token.

11. The non-transitory computer-readable medium of claim 10, wherein the obtaining one or more customer objects from a customer object database further comprises:
invoking a first call to a customer search API, wherein the first call to the customer search API comprises the customer data, the exchange access token, and the gateway access token.

12. The non-transitory computer-readable medium of claim 11, wherein the obtaining the customer lead identifier from the customer object database further comprises:
invoking a second call to a lead by customer identifier search API, wherein the second call to the lead by customer identifier search API comprises the customer identifier, the exchange access token, and the gateway access token.

13. The non-transitory computer-readable medium of claim 12, wherein the operations further comprise:
submitting a third request to a software-as-a-service (Saas) token service of the API exchange platform for a Saas token, wherein the third request comprises a user identifier and a dealer identifier; and
receiving, based on the third request, the Saas token.

14. The non-transitory computer-readable medium of claim 13, wherein the obtaining the lead object from the lead object database further comprises:
invoking a third call to a lead object search API, wherein the third call to the lead object search API comprises a lead source identifier, the customer lead identifier, the exchange access token, and the Saas token.

15. A system, comprising:
one or more processors; and
a memory communicatively coupled to the one or more processors, wherein the memory stores instructions that, when executed by the one or more processors, cause the one or more processors to perform operations comprising:
receiving customer data from a front-end interface of an agent workstation, wherein the customer data comprises a first name, a last name, an email address, and a phone number;
obtaining, based on the customer data, one or more customer objects from a customer object database, wherein each of the one or more customer objects comprises a customer identifier;
selecting the customer object that best matches the customer data;
obtaining, based on the customer identifier of the selected customer object, a customer lead identifier from the customer object database;
obtaining, based on the customer lead identifier, a lead object from a lead object database, wherein the lead object comprises one or more vehicle preferences, income data, and loan pre-approval status;
generating a link to the lead object from the lead object database; and
transmitting the link to the lead object to the front-end interface of the agent workstation.

16. The system of claim 15, wherein the operations further comprise:
submitting a first request to an exchange access token service of an application programming interface (API) exchange platform for an exchange access token, wherein the first request comprises an application identifier and an application secret;
obtaining, based on the first request, the exchange access token;
submitting a second request to a gateway access token service of an exchange partner gateway for a gateway access token, wherein the second request comprises the exchange access token and a subscription identifier; and
obtaining, based on the second request, the gateway access token.

17. The system of claim 16, wherein the obtaining one or more customer objects from a customer object database further comprises:
invoking a first call to a customer search API, wherein the first call to the customer search API comprises the customer data, the exchange access token, and the gateway access token.

18. The system of claim 17, wherein the obtaining the customer lead identifier from the customer object database further comprises:
invoking a second call to a lead by customer identifier search API, wherein the second call to the lead by customer identifier search API comprises the customer identifier, the exchange access token, and the gateway access token.

19. The system of claim 18, wherein the operations further comprise:
submitting a third request to a software-as-a-service (Saas) token service of the API exchange platform for a Saas token, wherein the third request comprises a user identifier and a dealer identifier; and
receiving, based on the third request, the Saas token.

20. The system of claim 19, wherein the obtaining the lead object from the lead object database further comprises:
invoking a third call to a lead object search API, wherein the third call to the lead object search API comprises a lead source identifier, the customer lead identifier, the exchange access token, and the Saas token.
